(19) United States
(12) Patent Application Publication
(10) Pub. No.: US 2023/0364695 A1
(43) Pub. Date: Nov. 16, 2023

(54) CHAIN SHARPENING JIG AND METHOD OF USING THE CHAIN SHARPENING JIG

(71) Applicant: Edward J. Dechant, Seattle, WA (US)

(72) Inventor: Edward J. Dechant, Seattle, WA (US)

(21) Appl. No.: 18/103,648

(22) Filed: Jan. 31, 2023

Related U.S. Application Data
(60) Provisional application No. 63/339,971, filed on May 10, 2022.

(51) Int. Cl. B23D 63/16

(52) U.S. Cl. CPC B23D 63/162

(57) ABSTRACT

The present disclosure relates a chain sharpening jig as well as method of using an existing chainsaw sharpener for machining tooth profile of chainsaw chains. The chain sharpening jig includes a slide base configured to be clamped to a universal chainsaw sharpener. A slide clamp is slidably arranged on the slide base. A chain holder is connected to the slide clamp and the chain holder is configured to receive the chainsaw chain. The chainsaw chain is configured to be machined by the grinding wheel of the universal chainsaw sharpener.

### CROSS-REFERENCE TO RELATED APPLICATIONS

The present application hereby claims priority to and incorporates by reference the entirety of the disclosure of the provisional application No. 63/339,971 entitled “Saw chain sharpening holder” filed on May 10, 2022.

### FIELD

The present disclosure generally relates to sharpening of chainsaw chains. More specifically it is related to a method of using an existing chainsaw sharpener for machining tooth profile of a chainsaw chain.

### BACKGROUND

Cutter tooth geometry determines the cutting characteristics of the saw chain depending on the material being cut. This characteristic is perceived by the chainsaw operator. For example, a soft material is easier to cut by the working edge of a chain cutter and thus, the operator can afford a sharper edge resulting in more production. Cutting hard material can dull the cutters faster than the operator prefers. The operator may enjoy a more durable cutter at the expense of a slower cut. A balance in durability and speed can be ideal for some operators and the ability to adjust these geometries can be advantageous.

In general, methods such as round filing and square filing are the most commonly used methods while sharpening a chain tooth of a chain. There are two common chainsaw cutter shapes, that is, semi chisel chainsaw cutter and full chisel chainsaw cutter. The semi chisel chainsaw cutters use a round outside corner so a round sharpener is preferred. Round sharpening creates a tooth that is durable and tends to be slower cutting. A semi-chisel chainsaw cutter has round-cornered tooth with a round ground edge which makes it easy to file. The semi chisel chainsaw chain generally cuts slower than a full chisel chainsaw cutter. Full chisel chainsaw cutters have a square outside corner (square-cornered tooth) and can be round filed. These cut faster than round sharpened semi chisel chainsaw cutters. The square filed method of sharpening is for full chisel chainsaw cutters only and the full chisel chainsaw cutters cut even faster than the round sharpened semi chisel chainsaw cutter. Semi Chisel chainsaw cutters are not generally square sharpened. A square ground tooth is sharpened with a beveled file or grinding wheel that matches to the corner of the cutter tooth to the corner of the beveled sharpening edge. The benefit of square sharpening a full chisel chainsaw cutter is that sharpness and cutter angles can be adjusted for desired performance and durability more accurately than the round sharpening method. For example, a square cutter in theory cuts 15-20% faster than a round cutter.

The top plate of a full chisel chainsaw cutter tooth has two changeable geometries that change cutting characteristics. The side plate of the chainsaw cutter also has two geometries that affect cutting characteristics. The chainsaw operator can benefit by variations of these four geometries independently whereas these geometries are harder or impossible to achieve with only a round sharpener.

The issue arises due to the precision required to perform the square sharpening. Hand filing can be difficult to learn and machine grinding is quite expensive. The square filing method is generally reserved for professionals requiring extreme needs as this type of chainsaw cutter tooth provides a smoother, and faster cutting chain.

However, the Automatic Chainsaw Grinder (U.S. Pat. No. 4,539,871) is the only grinder available on the market that will square grind chainsaw chain. Currently, with its robust and commercial duty design it carries a high cost and is quite complex. This solution is not ideal for a person who wants to try out square sharpening chainsaw chain as a hobbyist and enthusiast.

Universal Round grinders, also commonly known as “universal round cutters” as well as “round sharpening grinders” or “electric chainsaw grinders” (U.S. Pat. No. D757,514S1) are very common and low cost. These devices employ a high-speed rotating grinding wheel to grind round sharpened tooth chainsaw chain (semi-chisel chainsaw cutters and full chisel chainsaw cutters). However, most of the universal round grinders available lack the square sharpening function of machining square tooth chainsaw chains (Full chisel chainsaw cutters).

There is a need for a solution that utilizes a universal chainsaw chain grinder to perform sharpening of various types of chainsaw chains, including square tooth of full chisel chainsaw cutters as well as semi chisel chainsaw cutters.

The existing solutions related to dual purpose universal round grinders are ineffective and inefficient, and are complicated to use. In the light of the foregoing, there is a need for an efficient, dual-purpose, simple and effective solution that could be useful for maintenance of various types of chainsaw chains, with the ability to make easy variations in cutter sharpness and shape. Thus, there is need of a removable attachment (Jig) that could be used in conjunction with the existing universal round grinders such that the operator can perform the original (basic) function conventionally achieved using universal round grinders as well as the operator can perform the additional function of square sharpening a square tooth chainsaw chain by clamping the removable attachment to the universal round grinder.

### SUMMARY

While the way that the present disclosure addresses the disadvantages of the prior art will be discussed in greater detail below, in general, the present disclosure provides a chain sharpening jig that could be removably attached to a universal round grinder for sharpening various types of chains.

An object of the present disclosure is to provide a chain sharpening jig which is simple in structure.

Another object of the present disclosure is to provide a chain sharpening jig which is easy to use.

Yet another object of the present disclosure is to provide a chain sharpening jig which could be easily attached and detached from an existing universal chainsaw chain sharpener.

Yet another object of the present disclosure is to provide a chain sharpening jig which enables precise sharpening of chainsaw chains.

Further object of the present disclosure is to provide a chain sharpening jig which can sharpen different types of chainsaw chains.

Embodiments of the present invention disclose a chain sharpening jig configured to be removably attached to a universal chainsaw sharpener, the chain sharpening jig comprising: a slide base comprising a tab portion configured to be clamped inside a drive link clamp of the universal chainsaw sharpener; a slide clamp arranged on the slide base; a chain holder connected to the slide clamp; wherein the chain holder comprises: a first element, a second element, and a third element positioned between the first element and the second element; wherein the third element is connected to each of the first element and the second element to form a groove; wherein the groove is formed on the exterior surface of the third element between the first element and the second element; wherein a chainsaw chain to be machined is arranged in the groove; and a grinding wheel of the universal chainsaw sharpener is configured for machining the chainsaw chain arranged in the groove.

In an embodiment, the first element as well as the second element are substantially triangular shaped in nature.

In an embodiment, the first element as well as the second element are substantially pentagonal shaped in nature.

In an embodiment, the chain holder and the slide clamp are integrally connected to each other.

In an embodiment, the chain holder and the slide clamp are removably connected to each other.

In an embodiment, the chain holder comprises a through-hole, and the slide clamp comprises a central hole for enabling a screw to removably connect the chain holder and the slide clamp.

In an embodiment, the first element of the chain holder comprises a plurality of alignment holes, and the slide clamp comprises a plurality of alignment holes for enabling a plurality of dowel pins to align the chain holder relative to the slide clamp.

In an embodiment, the slide clamp comprises a through hole for enabling a tightening screw to slidably lock and unlock the slide clamp relative to the slide base.

In an embodiment, the second element has ruler markings extending along an edge of the second element.

In an embodiment, the second element has a central witness mark in proximity of an unsupported tip of the second element.

In an embodiment, the chain holder is replaceable.

In an embodiment, the slide clamp could axially translate relative to a sliding portion of the slide base.

Embodiments of the present invention further disclose a method of machining a chainsaw chain by utilizing an universal chainsaw sharpener, the method comprising the steps of: providing a chain sharpening jig, wherein the chain sharpening jig comprises: a slide base removably connected to a drive link clamp of the universal chainsaw sharpener; and a chain holder which further comprises: a first element, a second element, and a third element positioned between the first element and the second element; wherein the third element is connected to each of the first element and the second element to form a groove; wherein the groove is formed on the exterior surface of the third element between the first element and the second element; removably attaching a chain sharpening jig to the universal chainsaw sharpener; placing the chainsaw chain to be machined into the groove of the chain sharpening jig; Positioning a grinding wheel of the universal chainsaw sharpener in close proximity of the top of the chain holder in a generally vertical state such that the rotational axis of the grinding wheel is substantially parallel to the longitudinal axis of the slide base; bringing the grinding wheel towards the chainsaw chain in a substantially vertically downward direction to thereby contact against tooth of the chainsaw chain.

The present disclosure overcomes the drawbacks of the existing devices by providing a simple and easy to use device as well as method for enabling machining of different types of chainsaw chains by removably attaching the device to a conventional universal chain sharpener.

### BRIEF DESCRIPTION OF THE DRAWINGS

A more complete understanding of the present disclosure may be derived by referring to the detailed description and claims when considered in connection with the Figures, wherein reference numerals refer to similar elements throughout the Figures, and

FIG. 1 illustrates a front perspective view of a chain sharpening jig according to an embodiment of the present disclosure;

FIG. 2 illustrates an exemplary exploded view of a chain sharpening jig of FIG. 1;

FIG. 3 illustrates a front view of a chain sharpening jig of FIG. 1;

FIG. 4 illustrates a side view of a chain sharpening jig of FIG. 1;

FIG. 5 illustrates various perspective views of a chain holder of the chain sharpening jig of FIG. 1;

FIG. 6 illustrates various perspective views of a slide clamp of the chain sharpening jig of FIG. 1;

FIG. 7 illustrates a front perspective view of a chain sharpening jig of FIG. 1 clamped to a universal chainsaw chain sharpener, according to an embodiment of the present disclosure;

FIG. 8 illustrates a sectional perspective view of FIG. 7, wherein a grinding wheel of the universal chainsaw chain sharpener is machining a chainsaw chain using the chain sharpening jig of FIG. 1;

FIG. 9 illustrates a side view of the chain sharpening jig of FIG. 7, wherein the chain sharpening jig is clamped to the universal chainsaw chain sharpener;

FIG. 10 illustrates front views of various chain holders, according to various embodiments of the present disclosure;

FIG. 11 illustrates a front view of a chain holder, according to yet another embodiment of the present disclosure;

FIG. 12 illustrates a front perspective view of a slide base, according to yet another embodiment of the present disclosure;

FIG. 13 illustrates a side view of a chain sharpening jig of FIG. 1; wherein the chain holder is tilted with respect to the slide clamp, according to yet another embodiment of the present disclosure.

### DETAILED DESCRIPTION

The following description is of exemplary embodiments of the invention only, and is not intended to limit the scope, applicability, or configuration of the invention. Rather, the following description is intended to provide a convenient illustration for implementing various embodiments of the invention. As will become apparent, various changes may be made in the function and arrangement of the elements described in these embodiments without departing from the scope of the invention as set forth herein. It should be appreciated that the description herein may be adapted to be employed with alternatively configured devices having different shapes, components, attachment mechanisms and the like and still fall within the scope of the present invention. Thus, the detailed description herein is presented for purposes of illustration only and not of limitation.

Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

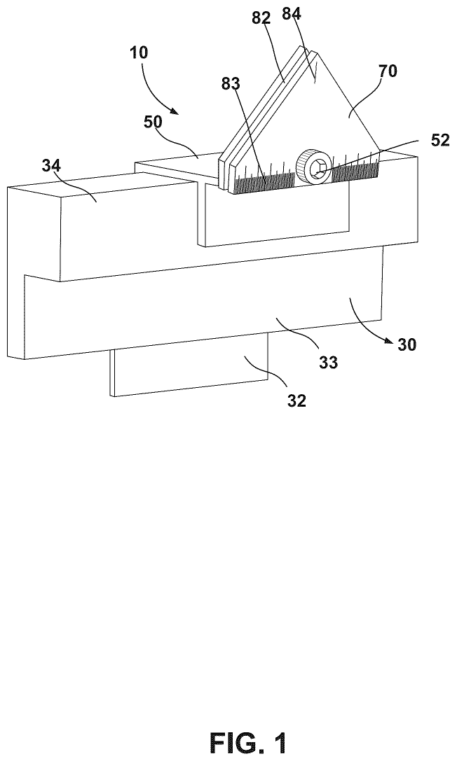

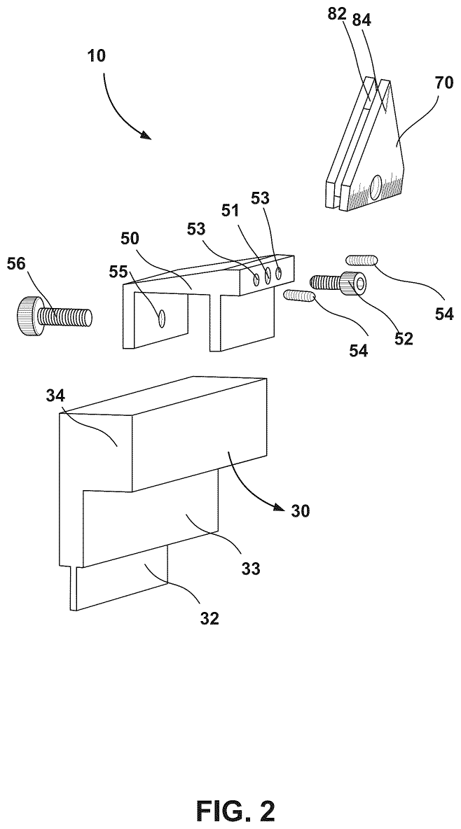

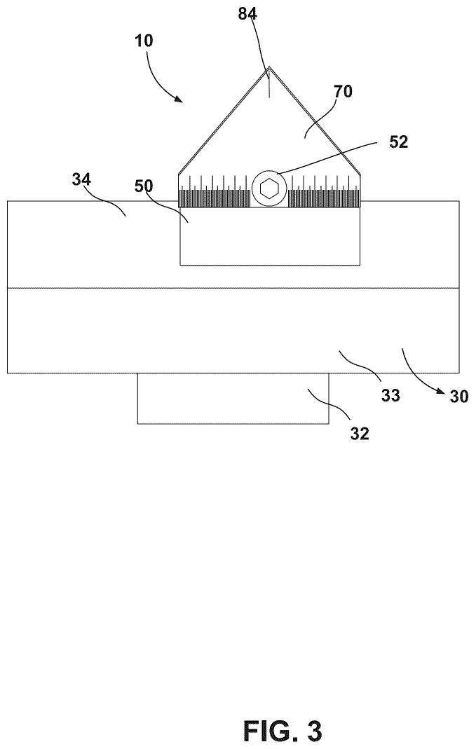

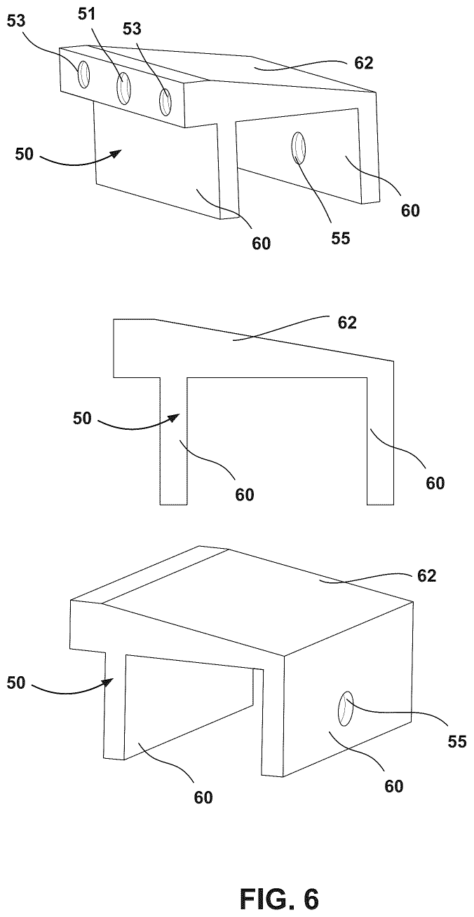

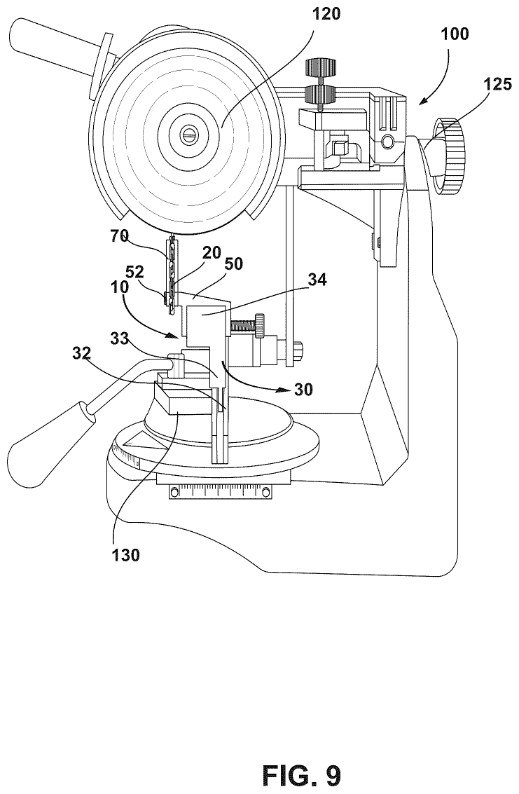

The chain sharpening jig 10 will now be described with reference to the accompanying drawings, particularly FIGS. 1-13.

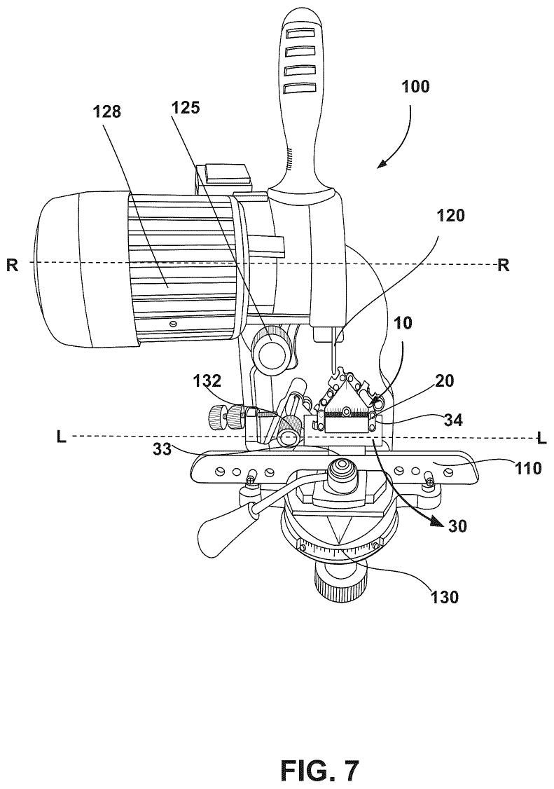

Reference is initially made to FIG. 1 which illustrates a perspective view of the chain sharpening jig 10, in accordance with an embodiment of the present disclosure. The chain sharpening jig 10 comprises a slide base 30, a slide clamp 50, and a chain holder 70, the entirety of which will be described in greater detail in the below description. The chain sharpening jig 10 is configured for machining (sharpening/grinding) various types of chainsaw chains 20 (FIG. 7). The term ‘chainsaw chains 20” as used in the present disclosure are intended to cut a variety of items such as wood, logs, timber, bushes, snow, plants, crops, trees, meat and the like. The chain sharpening jig 10 is configured to be installed (connected) in a universal chainsaw sharpener 100 (FIG. 7).

Referring to FIGS. 1-4, the slide base 30 comprising a tab portion 32 configured to be clamped inside a drive link clamp 110 (FIG. 7) of the universal chainsaw sharpener 100 (FIG. 7). Generally, the drive link clamp 110 is configured to accept chainsaw chains 20 (FIG. 7), in particular, semi-chisel chains 20 (FIG. 7). The slide base 30 further comprises a leveling portion 33 and a sliding portion 34. A slide clamp 50 is arranged on slide base 30.

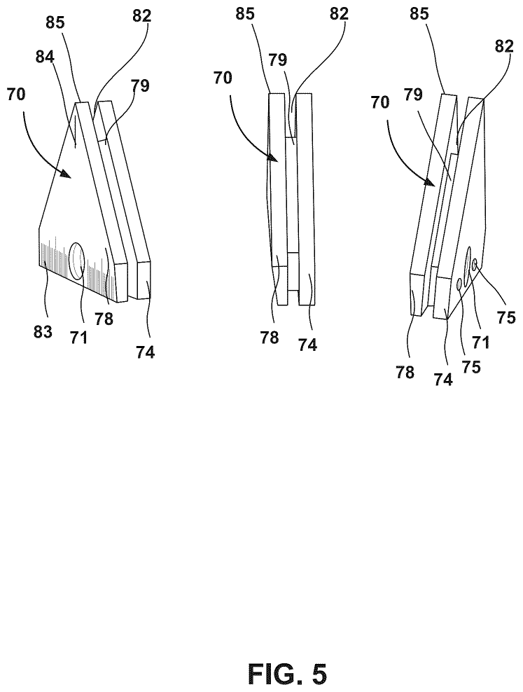

Referring to FIGS. 1-4 and FIG. 6, the slide clamp 50 comprises a pair of sidewalls 60 and a connecting portion 62. The sidewalls 60 are dimensioned to receive the sliding portion 34 of the slide base 30 such that the slide clamp 50 could slide relative to the slide base 30. At least one sidewall 60 comprises a through hole 55 such that a tightening screw 56 can be rotated to slidably lock and unlock the slide clamp 50 relative to the slide base 30. The connecting portion 62 further comprises a plurality of alignment holes 53 and a central hole 51. A screw 52 passes through the central hole 51 and a through-hole 71 (FIG. 5) of the chain holder 70 to removably connect the chain holder 70 and the slide clamp 50. A plurality of dowel pins 54 passes through the plurality of alignment holes 53 and the plurality of alignment holes 75 (FIG. 5) of the chain holder 70 to align the chain holder 70 relative to the slide clamp 50 in a substantially vertical direction as shown in FIGS. 1-4 such that each dowel pin 54 selected from a plurality of dowel pins 54 passes through an alignment hole 53 selected from plurality of alignment holes 53 and an alignment hole 75 (FIG. 5) selected from the plurality of alignment holes 75 (FIG. 5) of the chain holder 70.

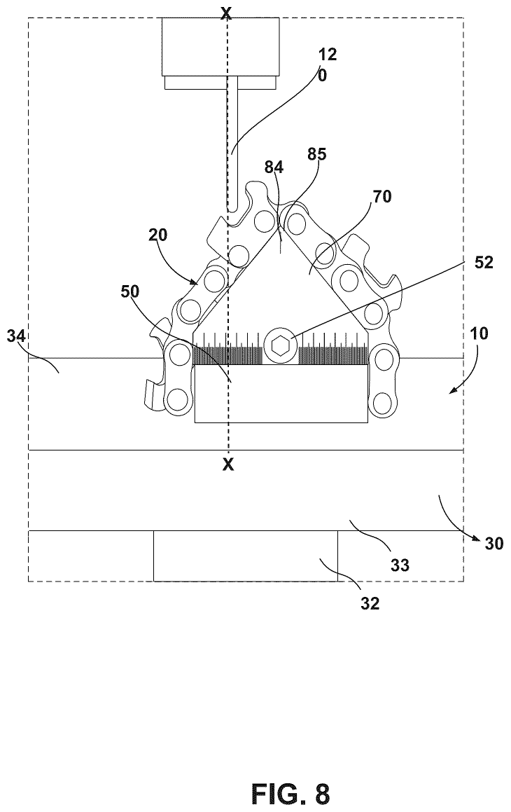

Referring to FIGS. 1-4 and FIG. 5, a chain holder 70 is removably connected to the slide clamp 50. The chain holder 70 comprises: a first element 74, a second element 78, and a third element 79 positioned between the first element 74 and the second element 78. The first element 74 comprises a plurality of alignment holes 75 and a through-hole 71. The through-hole 71 extends throughout the width of the chain holder 70. The second element 78 has ruler markings 83 extending along an edge of the second element 78. The second element 78 has a central witness mark 84 in the proximity of an unsupported tip 85 of the second element 78. The third element 79 is dimensioned to be set smaller than the first element 74 and the second element 78. The third element 79 is connected to each of the first element 74 and the second element 78 to form a groove 82, wherein the groove 82 is formed on the exterior surface of the third element 79 between the first element 74 and the second element 78. Groove 82 is dimensioned to receive at least a substantial (small) portion of the chainsaw chain 20 (FIG. 7) and the groove 82 is further configured to support the machining of a chainsaw chain 20 (FIG. 7) such that the chainsaw chain 20 that will be machined is arranged in the groove 82. The width of the groove 82 is dimensioned to provide a clearance fit over the width of the chainsaw chain 20. In an exemplary embodiment, the width of the groove 82 has a 007″ (inch) tolerance over the width of the chainsaw chain 20. Further, the groove 82 has a depth to receive at least a portion of the height of the chainsaw chain 20. The depth of the groove 82 is set smaller than the height of the chainsaw chain 20 such that at least some portion, in particular, cutting corner of the square tooth of chainsaw chain 20, extends outside the groove 82 as seen in FIG. 8.

In an exemplary embodiment as seen in FIG. 5, the first element 74, as well as the second element 78, are substantially triangular-shaped in nature. In another embodiment, the first element 74 as well as the second element 78 are substantially pentagonal shaped in nature.

The chain holder 70 determines the sharpness of the chainsaw tooth in relation to the top plate of a chainsaw tooth once the tooth of the chainsaw chain 20 is sharpened. In an exemplary embodiment, as shown in FIGS. 1-3 and FIG. 5, the chain holder 70 is a right-angled triangle with the 90-degree angle at the unsupported tip 85, therefore making a 45-degree angle on each side of the witness mark 84. By using the witness mark 84 and/or ruler markings 83, a user can visually look for the same (common) position on the chainsaw chain 20 between multiple links (tooth) for quick and easy machining of the chainsaw chain 20. The ruler markings 83 are further used to measure various positions/geometries of the chainsaw chain 20 to insure left- and right-hand chainsaw chains 20 are machined with same precision.

In an exemplary embodiment, the chain holder 70 is replaceable by removing the screw 52 passing through the central hole 51 as well as through-hole 71 and by removing the plurality of dowel pins 54 passing from the plurality of alignment holes 53 as well as plurality of alignment holes 75, detaching the chain holder 70 from the slide clamp 50 afterwards and then, replacing the old chain holder 20 by a new chain holder 20. Afterwards, the new chain holder 70 is attached to the slide clamp 50 and then, the screw 52 is re-inserted to pass through the central hole 51 as well as through-hole 71 of new chain holder 70 and the plurality of dowel pins 54 are re-inserted to pass through the plurality of alignment holes 53 as well as plurality of alignment holes 75, thereby effectively connecting the new chain holder 70 to the slide clamp 50.

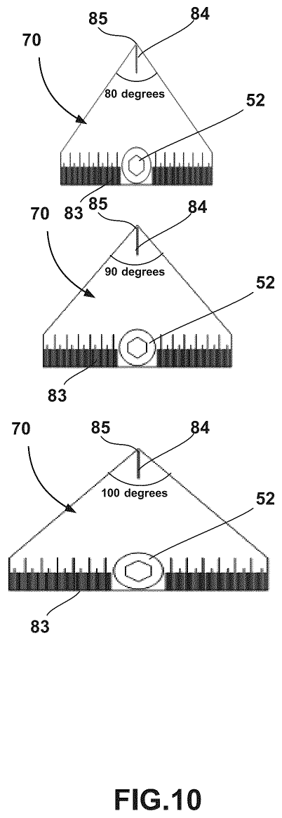

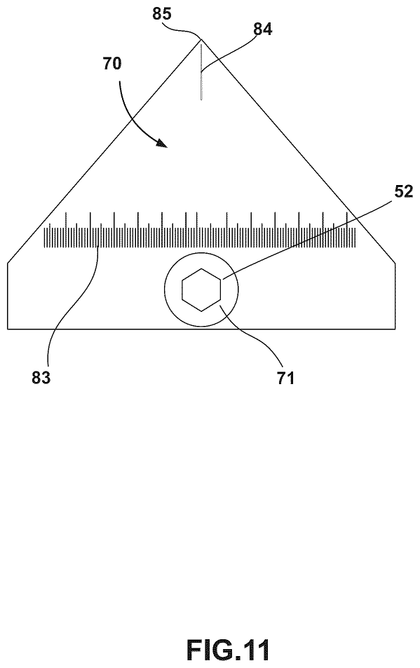

In various embodiments as seen in FIG. 10, the various chain holders 70 that could be used for replacement of the 90-degree chain holder 70 (FIG. 8) are: 80-degree chain holders, 100-degree chain holders, and so on. Further, in an exemplary embodiment as seen in FIG. 11, the chain holder 70 (FIG. 8) could also be replaced by another chain holder 70 as shown in FIG. 11. The chain holder 70 shown in FIG. 8 and the chain holder 70 shown in FIG. 11 are similar except for the geometric modifications associated with the position of the through-hole 71 and the configuration of the ruler markings 83.

In an exemplary embodiment, the chain holder 70 could include a shape altering (changing) mechanism for adjusting the overall geometry (shape) of the chain holder 70. As shown in FIGS. 1-3 and FIG. 5, the chain holder 70 is a right-angled triangle with the 90-degree angle at the unsupported tip 85, therefore making a 45-degree angle on each side of the witness mark 84. In an exemplary embodiment, the chain holder 70 could be adjusted using the shape-altering mechanism such that the chain holder 70 is an isosceles triangle with the 80-degree angle at the unsupported tip 85, therefore making a 40-degree angle on each side of the witness mark 84.

In an embodiment as seen in FIGS. 1-4, the chain holder 70 and the slide clamp 50 are removably connected to each other by using screw 52 and plurality of dowel pins 54. In another embodiment (not shown in figures), the chain holder 70 and the slide clamp 50 are integrally connected to each other by material/metal joining processes such as but not limited to welding, rivets, adhesive bonding, glues, friction locking, magnetic locking, electromagnetic locks, flange coupling, threaded coupling and so on.

In an exemplary embodiment as seen in FIG. 5, the first element 74, the second element 78, and the third element 79 are integrally connected. In another embodiment (not shown in figures), the first element 74, the second element 78, and the third element 79 are detachably connected to each other. This configuration allows quick and easy replacement (detachment) of the second element 78 and/or the third element 79 from the first element 74, thus enabling a single (common) first element 74 to be connected to a variety of second element 78 and/or the third element 79, wherein the second element 78 and/or the third element 79 could be selectively chosen depending on the overall dimensions of the chainsaw chain 20.

FIG. 7 illustrates a front perspective view of a chain sharpening jig 10 of FIG. 1 clamped to the universal chainsaw chain sharpener 100, according to an embodiment of the present disclosure. As seen in FIG. 7, the grinding wheel 120 of the universal chainsaw chain sharpener 100 is set in a generally vertical state. The peripheral side of the grinding wheel 120 and the chainsaw chain 20 cuts the tooth at a 45-degree of angle to the chainsaw chain 20 as further seen in FIG. 8.

As shown in FIGS. 7-9, The universal chainsaw sharpener 100 is a conventional electric grinder that already exists in the market and is sold by various merchandise/brands using various product names on different selling platforms. In an exemplary embodiment, the universal chainsaw sharpener could be a product named “Oregon 410-120 Bench Chain Sharpener” or alternatively, the universal chainsaw sharpener 100 could be chainsaw sharpener disclosed in U.S. D757,514S1 titled “Chainsaw sharpener”. The universal chainsaw sharpener 100 has a yaw or left to right rotation mechanism 125, a ten-degree swing or pitch mechanism 130 from front to back and an upper portion with motor 128, and a grinding wheel 120 pivoting toward the chain tooth from a fulcrum point. The universal chainsaw sharpener 100 has a drive link clamp 110 that generally acts as a vise assembly to hold chainsaw chains 20 to be machined, in particular semi-chisel chains 20. A cutter stop 132 is mounted on the drive link clamp 110 to selectively lock and unlock the movement of the chainsaw chain 20.

As shown in FIGS. 7-9, the chainsaw chain 20 is a conventional right-hand square tooth chainsaw chain 20 with multiple links, already existing in the market. Each link of the chainsaw chain 20 includes a top plate (tooth), a cutting corner of the tooth, and a raker. The cutting corner of the tooth of the chainsaw chain 20 has a square profile, and could also be referred to as “square tooth chainsaw chain 20”.

In an exemplary embodiment as seen in FIG. 8, right hand chainsaw chains 20 are sharpened on the left side of the chain holder 70, in particular on left side of the witness mark 84. In another exemplary embodiment, left hand chainsaw chains 20 are sharpened on the right side of the chain holder 70, in particular in right side of the witness mark 84. The grinding wheel 120 is positioned vertically and perpendicular to the slide base 30 as seen in FIG. 7. The grinding wheel 120 is centered above the chainsaw chain 20 in a location between the drag (also known as raker) and the working edge of the tooth of chainsaw chain 20. The imaginary straight line, designated as X-X passing through the left side of the grinding wheel 120 through the chainsaw chain 20 determines where the corner of the grinding wheel 120 meets with the corner of the working edge of the tooth of chainsaw chain 20.

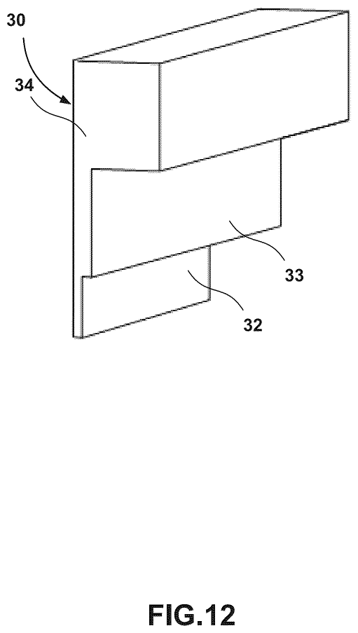

FIG. 12 illustrates a front perspective view of a slide base 30, according to yet another embodiment of the present disclosure. The tab portion 32, the leveling portion 33 and the sliding portion 34 are configured such that the slide base 30 has a generally stepped (stair-like) profile as seen in FIG. 12.

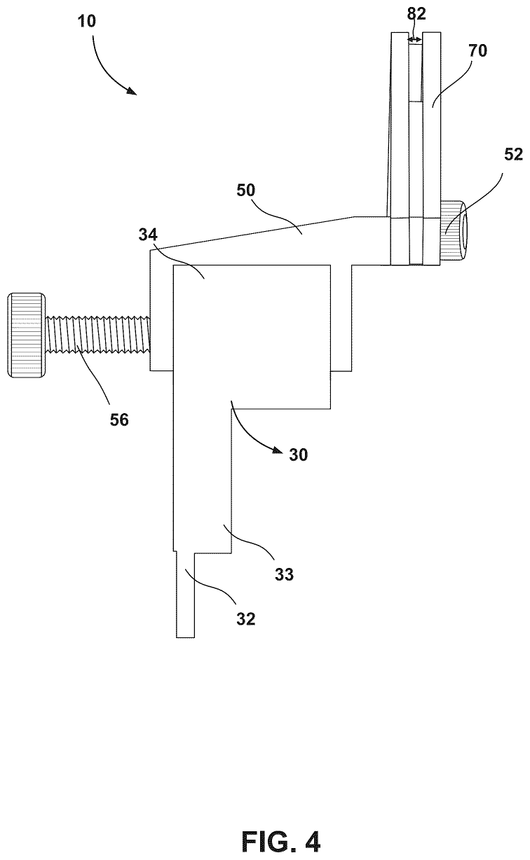

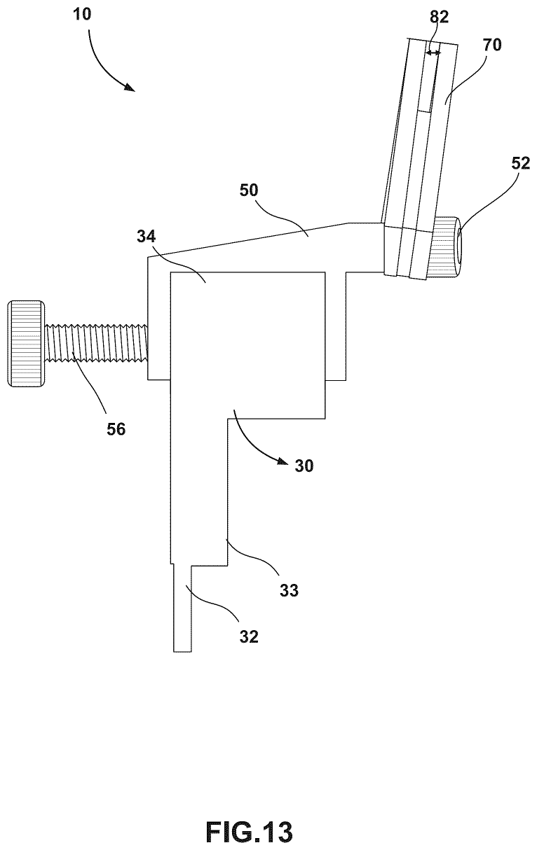

FIG. 13 illustrates a side view of a chain sharpening jig of FIG. 1; wherein the chain holder 70 is tilted with respect to the slide clamp 50, according to yet another embodiment of the present disclosure. The chain holder 70 shown in FIG. 13 is similar to chain holder 70 shown in FIG. 4 except for the angle of the chain holder 70 relative to the slide clamp 50. The tilted chain holder 70 shown in FIG. 13 enables a variation of cutting angles of square tooth chainsaw chain 20, depending on the requirement of square tooth chainsaw chain 20.

An exemplary method of machining a chainsaw chain 20 by utilizing a universal chainsaw sharpener 100 will now be described in reference to FIGS. 1-9.

Initially, a chain sharpening jig 10 is removably attached to the universal chainsaw sharpener 100. Afterward, the chainsaw chain 20 to be machined is placed into the groove 82 of the chain sharpening jig 10. The universal chainsaw sharpener 100 (FIG. 7) has a yaw or left to right rotation mechanism 125, a ten-degree swing or pitch mechanism 130 from front to back, and an upper portion with motor 128 and a grinding wheel 120 pivoting toward the chain tooth from a fulcrum point. A cutter stop 132 is mounted on the drive link clamp 110 to selectively lock and unlock the movement of the chainsaw chain 20. The operator can adjust at least one of: yaw or left to right rotation mechanism, a ten-degree swing or pitch mechanism and cutter stop to control desired machining process of the chainsaw chain 20. Afterwards, the motor of the universal chainsaw sharpener 100 is activated to rotate the grinding wheel 120. Then, the grinding wheel 120 of the universal chainsaw sharpener 100 is positioned in close proximity of the top of the chain holder 70 in a generally vertical state such that the rotational axis (designated as dotted line R-R in FIG. 7) of the grinding wheel 120 is substantially parallel to the longitudinal axis (designated as dotted line L-L in FIG. 7) of the slide base 30. Then, the grinding wheel 120 is brought towards the chainsaw chain 20 in a substantially vertically downward direction to contact against tooth of the chainsaw chain 20, thereby machining the tooth of the chainsaw chain 20.

As shown in FIG. 7, the longitudinal axis (designated as dotted line L-L in FIG. 7) of the slide base 30 is substantially parallel to the rotational axis (designated as dotted line R-R in FIG. 7) of the grinding wheel 120. Further, the longitudinal axis (designated as dotted line L-L in FIG. 7) of the slide base 30 is parallel to the longitudinal axis of the drive link clamp 110 and it should be understood that the longitudinal axis of the drive link clamp 110 is also substantially parallel to the rotational axis (designated as dotted line R-R in FIG. 7) of the grinding wheel 120.

It should be well understood that the chain sharpening jig 10 could also be used for machining round tooth chainsaws 20 with precision. Typically, the universal chainsaw sharpener 100 machines into (towards) the tooth profile on round tooth right-hand chainsaw chains 20 and the universal chainsaw sharpener 100 machines out (away) of the tooth profile on round tooth left-hand chainsaw chains 20. Machining the tooth profile on round tooth left-hand chainsaw chains 20 using the universal chainsaw sharpener 100 alone creates a burr on the tooth profile of round tooth left-hand chainsaw chains 20, which is a drawback and thus, the operator needs manual filing to remove burrs from the tooth profile of round tooth left-hand chainsaw chains 20. However, the advantage of using chain sharpening jig 10 in conjunction with the universal chainsaw sharpener 100 to machine round tooth left-hand chainsaw chains 20 eliminates this drawback. Thus, the addition of the chain sharpening jig 10 enables the universal chainsaw sharpener 100 to cut both round tooth left-hand chainsaw chains 20 as well as round tooth right-hand chainsaw chains 20. Further, the operator can detach the chain sharpening jig 10 from the universal chainsaw sharpener 100 and thus, the operator can do machining of round tooth chainsaws 20 using universal chainsaw sharpener 100 alone without using chain sharpening jig 10, thereby enabling the operator to perform conventional machining of round tooth chainsaws 20.

In an exemplary embodiment, the material for the chain sharpening jig 10 could include any rigid material that does not bend (deform) so the angle of the tooth of chainsaw chain 20 during machining is constant. In an embodiment, the material for the chain sharpening jig 10 could include but not limited to: delrin, aluminum, titanium, steel, iron and so on.

In an exemplary embodiment, the slide clamp 50 could slide relative to the slide base 30 with minimum friction using at least one of: bearings and mechanical slide. The slide clamp 50 and/or the slide base 30 could include bearings such as but not limited to: ball bearing, plain bearings, roller bearings, needle bearings, and so on. The slide clamp 50 and/or the slide base 30 could include slides such as but not limited to ball bearing slides, mechanical drawer slides, Telescopic slides, and so on.

Finally, while the present invention has been described above with reference to various exemplary embodiments, many changes, combinations, and modifications may be made to the exemplary embodiments without departing from the scope of the present invention. For example, the various components may be implemented in alternative ways. These alternatives can be suitably selected depending upon the particular application or in consideration of any number of factors associated with the operation of the device. In addition, the techniques described herein may be extended or modified for use with other types of devices. These and other changes or modifications are intended to be included within the scope of the present invention.

What is claimed is:

1. A chain sharpening jig (10) configured to be removably attached to a universal chainsaw sharpener (100), the chain sharpening jig (10), comprising:
a slide base (30) comprising a tab portion (32) configured to be clamped inside a drive link clamp (110) of the universal chainsaw sharpener (100);
a slide clamp (50) arranged on the slide base (30);
a chain holder (70) connected to the slide clamp (50); wherein the chain holder (70) comprises:
a first element (74), a second element (78), and a third element (82) positioned between the first element (74) and the second element (78);
wherein the third element (82) is connected to each of the first element (74) and the second element (78) to form a groove (82); wherein the groove (82) is formed on the exterior surface of the third element (82) between the first element (74) and the second element (78); and
wherein a chainsaw chain (20) to be machined is arranged in the groove (82); and a grinding wheel (120) of the universal chainsaw sharpener (100) is configured for machining the chainsaw chain (20) arranged in the groove (82).

2. The chain sharpening jig (10) according to claim 1, wherein the first element (74) as well as the second element (78) are substantially triangular shaped in nature.

3. The chain sharpening jig (10) according to claim 1, wherein the first element (74) as well as the second element (78) are substantially pentagonal shaped in nature.

4. The chain sharpening jig (10) according to claim 1, wherein the chain holder (70) and the slide clamp (50) are integrally connected to each other.

5. The chain sharpening jig (10) according to claim 1, wherein the chain holder (70) and the slide clamp (50) are removably connected to each other.

6. The chain sharpening jig (10) according to claim 1, wherein the chain holder (70) comprises a through-hole (71), and the slide clamp (50) comprises a central hole (51) for enabling a screw (52) to removably connect the chain holder (70) and the slide clamp (50).

7. The chain sharpening jig (10) according to claim 1, wherein the first element (74) of the chain holder (70) comprises a plurality of alignment holes (75), and the slide clamp (50) comprises a plurality of alignment holes (53) for enabling a plurality of dowel pins (54) to align the chain holder (70) relative to the slide clamp (50).

8. The chain sharpening jig (10) according to claim 1, wherein the slide clamp (50) comprises a through hole (55) for enabling a tightening screw (56) to slidably lock and unlock the slide clamp (50) relative to the slide base (30).

9. The chain sharpening jig (10) according to claim 1, wherein the second element (78) has ruler markings (83) extending along an edge of the second element (78).

10. The chain sharpening jig (10) according to claim 1, wherein the second element (78) has a central witness mark (84) in proximity of an unsupported tip (85) of the second element (78).

11. The chain sharpening jig (10) according to claim 1, wherein the chain holder (70) is replaceable.

12. The chain sharpening jig (10) according to claim 1, wherein the slide clamp (50) could axially translate relative to a sliding portion (34) of the slide base (30).

13. A method of machining a chainsaw chain (20) by utilizing a universal chainsaw sharpener (100), the method comprising the steps of:
providing a chain sharpening jig (10), wherein the chain sharpening jig (10) comprises: a slide base (30) removably connected to a drive link clamp (110) of the universal chainsaw sharpener (100); and a chain holder (70) which further comprises: a first element (74), a second element (78), and a third element (82) positioned between the first element (74) and the second element (78); wherein the third element (82) is connected to each of the first element (74) and the second element (78) to form a groove (82); wherein the groove (82) is formed on the exterior surface of the third element (82) between the first element (74) and the second element (78);
removably attaching a chain sharpening jig (10) to the universal chainsaw sharpener (100);
placing the chainsaw chain (20) to be machined into the groove (82) of the chain sharpening jig (10);
positioning a grinding wheel (120) of the universal chainsaw sharpener (100) in close proximity of the top of the chain holder (70) in a generally vertical state such that the rotational axis of the grinding wheel (120) is substantially parallel to the longitudinal axis of the slide base (30); and
bringing the grinding wheel (120) towards the chainsaw chain (20) in a substantially vertically downward direction to thereby contact against tooth of the chainsaw chain (20).

14. The method of machining a chainsaw chain (20) according to claim 13, wherein the chainsaw chain (20) is a square tooth chainsaw chain (20).
